(19) United States
(12) Patent Application Publication
(10) Pub. No.: US 2013/0207754 A1
(43) Pub. Date: Aug. 15, 2013

(54) MAGNETIC FLUX SWITCH

(71) Applicants: Alan S. Edelstein, Alexandria, VA (US); Gregory A. Fischer, Ellicott City, MD (US); Jonathan E. Fine, Silver Spring, MD (US)

(72) Inventors: Alan S. Edelstein, Alexandria, VA (US); Gregory A. Fischer, Ellicott City, MD (US); Jonathan E. Fine, Silver Spring, MD (US)

(73) Assignee: U.S. Government as represented by the Secretary of the Army, Adelphi, MD (US)

(21) Appl. No.: 13/597,529

(22) Filed: Aug. 29, 2012

Related U.S. Application Data
(60) Provisional application No. 61/598,494, filed on Feb. 14, 2012.

(51) Int. Cl. H01H 9/00

(52) U.S. Cl. 335/205

(57) ABSTRACT

A magnetic flux switch having a substrate and an elongated rod having a first end attached to the substrate and a magnetic material attached to the second end. An electrostatic comb drive pivots the rod between a first and second pivotal position in dependence upon the input signal for the comb drive. In its first position the magnetic material is positioned closely adjacent a magnetic flux sensor on the substrate so that flux flow through the rod flows through the sensor which then generates an output signal. Conversely, with the rod in its second position, the magnetic material is spaced from the sensor so that flux does not flow through the magnetic flux sensor.

### CROSS-REFERENCE TO RELATED APPLICATIONS

This application claims priority of U.S. Provisional Application 61/598,494, filed Feb. 14, 2012, the contents of which are incorporated herein by reference.

### GOVERNMENT INTEREST

The invention described herein may be manufactured, used, and licensed by or for the United States Government.

### BACKGROUND

I. Field of Use

The present invention relates to magnetic flux switches.

II. Description of Related Art

Generally, most high sensitivity magnetic sensors used to measure magnetic field strength do not reach their full potential, The sensing technique utilized by high sensitivity magnetic sensors is typically hampered by noise constraints. A main component of this noise is “1/f noise,” also known as Flicker noise, which is a signal or process with a frequency spectrum that lessens at higher frequencies. Pink noise patterns are also referred to as “1/f noise,” and are found in semiconductors, music melodies, atomic clocks, and in nature, including the sounds of wind and waterfalls. 1f noise occurs in almost all electronic devices, and results from a variety of effects. For applications where detection of low frequency phenomena is critical, 1/f noise is a major problem. Thus, there is a need to mitigate the effect of 1/f noise.

Interest is increasing in the development of miniature sensors for sensing magnetic fields, such as, for example, extraterrestrial, industrial, biomedical, oceanographic, and environmental applications. The trend in magnetic sensor design and development is toward smaller size, lower power consumption, and lower cost for similar or improved performance.

Currently, several types of magnetometers, which are magnetic sensors with external instrumentation, are in use. The least expensive and least sensitive devices have a resolution of approximately 10⁻¹ Oersted (Oe)/Hz^{1/2} and typically are Hall-effect devices. These devices operate by sensing a voltage change across a conductor or semiconductor placed in a magnetic field. However, such devices generally do not lend themselves for applications requiring greater sensitivity, such as required, for example, in brain scan devices and magnetic anomaly detection devices.

Flux gate magnetometers are more sensitive than Hall-effect devices; having a resolution of approximately 10⁻⁶ Oe/Hz^{1/2}. Flux gate magnetometers use a magnetic core surrounded by an electromagnetic coil, and are generally difficult to micro-fabricate. Additionally, flux gate magnetometers typically require a relatively large amount of power and accordingly do not lend themselves to a low-cost, compact, portable design.

Another way of increasing the sensed magnetic field by a magnetic sensor is by use of a flux concentrator, which can enhance a sensed magnetic field by factor of 1.5 to as much as 100. Flux concentrators are described further in U.S. application Ser. No. 12/536,213 filed Aug. 5, 2009, entitled “MEMS Device with Supplemental Flux Concentrator,” and U.S. application Ser. No. 12/541,805 filed Aug. 14, 2009, entitled “MEMS Device With Tandem Flux Concentrators and Method of Modulating Flux,” hereby incorporated by reference. In our earlier invention, Ser. No. 12/854,321 filed Aug. 11, 2010, we described how the field at the position of the sensor could be changed by placing the sensor on cantilever that pivoted from one end. The other end moved out of the plane. The motion was driven by using the electrostatic force generated by PZT. No resonant frequency was involved nor was there any discussion of using the device for larger sensors.

The present invention does not place the sensor on the moving structure. The motion is in the plane. The motion is driven by electrostatic forces, not electrostatic forces. The device operates at a resonant frequency and is designed to operate with larger sensors.

SQUIDS (superconducting quantum interference detectors) are more sensitive magnetometers having a resolution of approximately 10⁻¹⁰ Oe/Hz^{1/2}. However, because SQUIDS include a superconducting element, these apparatus typically must include cooling means at liquid gas temperatures, making them extremely bulky and expensive to operate. Also their relatively large size generally limits their utility because the active superconducting element cannot be placed directly adjacent to the source of the magnetic field. As such, it is common in magnetic sensors to place the sense element between two stationary flux concentrators to enhance the field. See, for example, U.S. application Ser. No 12/536,213, filed Aug. 5, 2009, entitled “MEMS Device with Supplemental Flux Concentrator,” and U.S. application Ser. No. 12/541,805 filed Aug. 14, 2009, entitled “MEMS Device with Tandem Flux Concentrators and Method of Modulating Flux.” The disclosures of each of the above-mentioned applications are incorporated herein by reference in their entirety.

Furthermore, magnetic sensors used to detect objects that move slowly typically possess considerably low frequency 1/f-type noise, which is an unwanted condition. Generally, there is a tendency for such devices, which have higher sensitivity, to also exhibit higher 1/f-type noise. This type of noise generally occurs when using magneto resistive-type magnetic sensors.

Another problem arising with magnetic sensor usage occurs when detecting change in a signal due to the influence of a magnetic field, The signal change may be small relative to a background signal or signals; referred to herein as the “DC offset.” For example, in spin valve giant magneto resistor sensors, the change is approximately 5-10%. For anisotropic magneto resistance sensors the measurable change is even smaller. Extracting the measured signal from the DC offset requires using carefully constructed bridges and other techniques.

U.S. Pat. No. 7,185,541 issued Feb. 2, 2010, hereby incorporated by reference, entitled “MEMS Structure Support and Release Mechanism,” discloses a MEMS device and method comprising, inter alia, a MEMS structure adjacent to a SOI base; a sacrificial support operatively connecting the base to the MEMS structure; a suspension member operatively connecting the base to the MEMS structure. An embodiment in U.S. Pat. No. 7,655,996 further comprises a current pulse generator adapted to send a current pulse through the sacrificial support, wherein the current pulse causes the sacrificial support to detach from the MEMS structure.

In U.S. Pat. No. 7,046,002, a flux concentrator system is disclosed wherein the flux concentrators “focus” the magnetic field lines at the sensor location. The flux concentrators are free to move, driven by a comb drive, thus modulating the field at the position of the sensor. When the frequency of oscillation is in the kilohertz range, low frequency signals of interest that are normally obscured by the 1/f noise (which dominates at low frequencies) are effectively shifted to higher frequencies where 1/f noise is significantly lower. The sensor is stationary, the flaps oscillate, and comb drives and silicon springs are required.

There have been efforts to increase the operating frequency to where 1/f noise is lower by modulating the magnetic field at the position of magnetic sensors. Such efforts include the MEMS flux concentrator (U.S. Pat. No. 6,501,268) and using a rotating disc (U.S Pat. No. 7,898,247). The MEMS flux concentrator only works on small, micron sized sensors. The rotating disk generates acoustic noise. The present invention will modulate the magnetic field at the position of sensors that are roughly one or two hundred microns in size and, because there are no very large moving parts, the acoustic noise should be small. The Applicants' previous invention, the MEMS flux concentrator (U.S. Pat. No. 6,501,268), is suited for the smaller sub 10 micron sensors. This invention represents a similar approach, but for larger or “mid-sized” sensors. Additionally, the Applicants have another previously disclosed invention, “Concept for significant improvement in design and fabrication of a MEMS flux concentrator” (U.S. patent application Ser. No. 12/854,321 filed Aug. 11, 2010 that is similar to this disclosure. In the previous case, the magnetic material pivots in an “up and down” motion.

The disclosures of each of the above-mentioned patents and copending applications are incorporated herein by reference in their entirety.

### SUMMARY

The present invention provides an improved magnetic flux switch which overcomes many of the disadvantages of the previously known flux switches.

In brief, the magnetic flux switch of the present invention includes a substrate which may he constructed of any suitable material, such as silicon. An elongated rod has one end attached to the substrate and a magnetic material attached to its other or free end.

A magnetic flux sensor is positioned on the substrate.

A drive then moves the rod in response to an input signal between a first pivotal position and a second pivotal position. In its first pivotal position, the magnetic material attached to the rod is positioned adjacent the magnetic flux sensor so that magnetic flux flowing in the direction of the rod and through the magnetic material also flows through the magnetic flux sensor and detected by the magnetic flux sensor. Conversely, in its second position, the magnetic material attached to the free end of the rod is spaced apart from the magnetic sensor so that magnetic flux flowing through the magnetic material in the direction of the rod substantially bypasses the magnetic sensor. Thus, by modulating the rod with its attached magnetic material between the first and second position, the effective frequency of the magnetic field may be increased thereby reducing the effect of 1/f noise noise.

### BRIEF DESCRIPTION OF THE DRAWING

A better understanding of the present invention will be had upon reference to the following detailed description when read in conjunction with the accompanying drawing wherein like reference characters refer to like parts throughout the several views and in which:

FIG. 1 is a plan view illustrating an embodiment of the magnetic flux sensor of the present invention in a neutral position;

FIG. 2 is a view similar to FIG. 1, but illustrating the magnetic flux sensor in a first position in which the magnetic flux passes through and is detected by a magnetic flux sensor; and

FIG. 3 is a view similar to FIGS. 1 and 2, but illustrating the magnetic material in a second position in which the magnetic flux bypasses the magnetic flux sensor.

### DETAILED DESCRIPTION

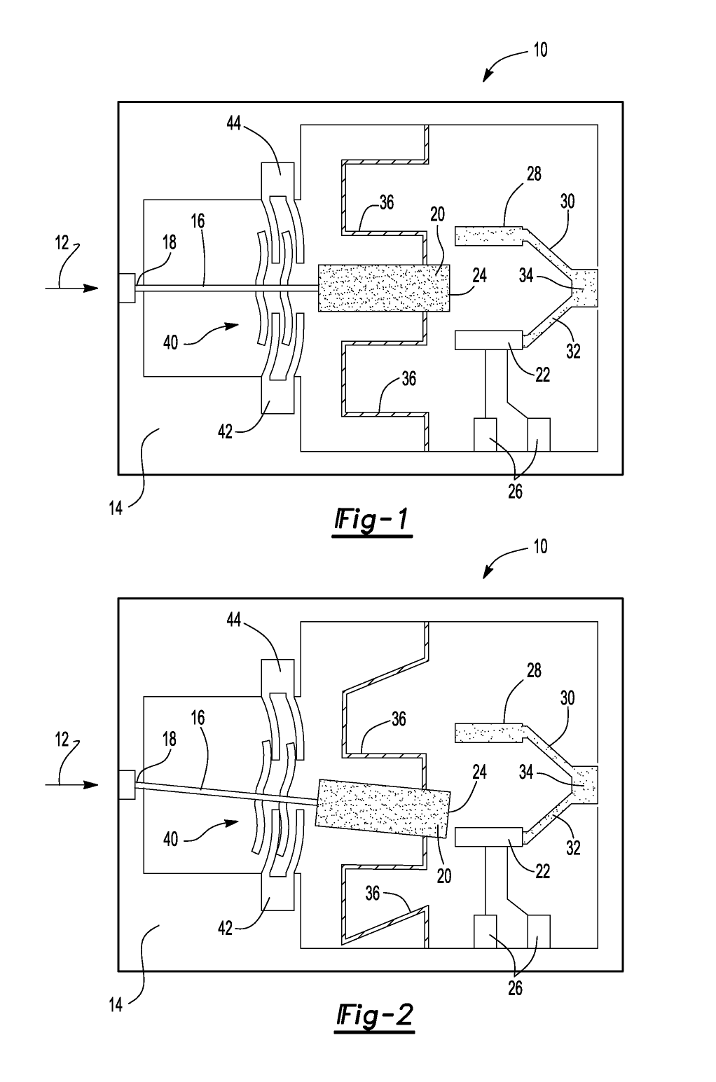

With reference first to FIG. 1, one embodiment of a magnetic flux switch 10 in accordance with the present invention is shown. The magnetic flux switch 10 is oriented to react to magnetic flux flowing in the direction indicated by an arrow 12.

The magnetic flux switch 10 includes a substrate 14 that may be constructed of any suitable material, such as silicon. Other materials, however, may be used as the substrate 14 without deviation from the spirit or scope of the invention.

An elongated rod 16 has one end 18 attached to the substrate 14 and a magnetic material 20 attached to its opposite or free end. Any type of high magnetic permeability material 20 may be used such as permalloy or metglas. Consequently, with the rod 16 and magnetic material 20 oriented as shown in FIG. 1, the magnetic flux extends longitudinally along the direction of the rod 16 and through the magnetic material.

A magnetic sensor 22 is also supported by the substrate 14 at a position spaced longitudinally outwardly in the direction 12 of the flux beyond a free end 24 of the magnetic material 20. This magnetic sensor 22 may be of any conventional construction and generates a signal to its output pads 26 indicative of the magnitude of magnetic flux detected by the sensor 22.

A second and stationary high magnetic permeability material 28 is also supported by the substrate 14. This magnetic, material 28 is positioned apart from the magnetic sensor 22. Furthermore, a pair of magnetic pads 30 and 32 magnetically couple the stationary magnetic material 28 and magnetic sensor 22 to a magnetic output 34 on the substrate 14.

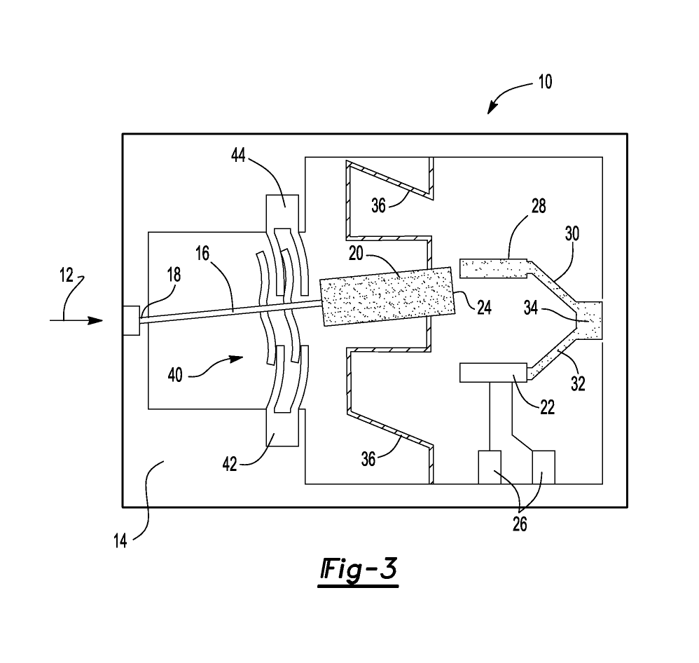

With reference now to FIGS. 1-3, the rod 16 with its attached magnetic material 20 is pivotal between a first position, illustrated in FIG. 2, and a second position, illustrated in FIG. 3. In its first position (FIG. 2) the magnetic material 20 attached to the rod 16 is positioned closely adjacent, and preferably aligned with, the magnetic flux sensor 22. Consequently, flux flowing in the direction of arrow 12 passes through the magnetic material 20 attached to the rod 16 and sensor 22 to the magnetic output 34. This flux is detected by the magnetic sensor 22 which generates an output to its output contacts 26.

Conversely, with the rod 16 and magnetic material 20 mounted to the rod 16 in its second position (FIG. 3) the magnetic material 20 attached to the rod 16 is positioned closely adjacent, and in embodiments aligned with, the magnetic material 28 on the substrate 14. Furthermore, with the magnetic material 20 in its second position, the magnetic material 20 is further away from the sensor 22 than in its first position. Consequently, when in its second position, magnetic flux in the direction of arrow 12 passes through the magnetic material 20, the magnetic material 28 on the substrate 14, and through the magnetic pad 30 to the magnetic output 34. Consequently, in its second position, the magnetic sensor 22 detects a much smaller, magnetic field than with the magnetic material 20 in its first position.

In embodiments, one or more springs 36 are employed to maintain the rod 16 and the magnetic material 20 mounted to the rod 16 in a central or neutral position illustrated in FIG. 1. Any conventional drive mechanism may be used to pivot the rod 16 with its attached magnetic material 20 between its first and second position. However, as illustrated in FIG. 1, an electrostatic comb drive 40 is used to pivot the rod 16 and its attached magnetic material 20 between the first and second position.

Consequently, with reference to FIG. 2, the application of a voltage differential between the rod 16 and a comb drive contact 42 on one side of the rod 16 will cause the comb drive 40 to pivot the rod 16 to its first position due to the capacitive coupling of the comb drive 40. Conversely, as shown in FIG. 3, the application of a differential voltage between the rod 16 and a comb drive contact 44 will cause the rod 16 with its attached magnetic material 20 to pivot to its second position. When no differential voltage is applied between the rod 16 and either comb drive contact 42 or 44, the springs 36 return the rod 16 and its attached magnetic material 20 to a central or neutral position illustrated in FIG. 1.

From the foregoing, it can be seen that in embodiments the present invention provides a magnetic flux switch capable of switching the flux in the direction of arrow 12 either through the magnetic sensor 22 or bypassing the magnetic sensor 22 depending on the pivotal position of the rod 16 with its attached magnetic material 20. Consequently, by the application of the appropriate signal to the contacts 42 and 44 of the comb drive 40, the effective frequency of the sensed magnetic flux may be effectively increased so that the magnetic output from the magnetic sensor 22 is less affected by 1/f noise. Similarly, any signal, such as a sinusoidal or square wave signal, may be used to modulate the position of the rod 16 with its attached magnetic material 20 and likewise modulate the output from the magnetic sensor 22.

From the foregoing, it can be seen that in embodiments the present invention provides a simple yet effective magnetic flux switch. Having described our invention, however, many modifications thereto will become apparent to those skilled in the art to which it pertains without deviation from the spirit of the invention as defined by the scope of the appended claims.

We claim:

1. A magnetic flux switch comprising:
a substrate,
an elongated rod having one end attached to said substrate,
a magnetically soft material attached to the other end of said rod,
a magnetic flux sensor positioned on said substrate adjacent said magnetic material,
a drive which moves said rod between a first pivotal position in which said magnetic material is positioned adjacent said magnetic flux sensor, arid a second position in which said magnetic material is more spaced from said magnetic flux sensor than in said first position.

2. The magnetic flux switch as defined in claim 1 wherein said magnetic material and a portion of said rod are aligned with said magnetic flux sensor when said rod is in said first position.

3. The magnetic flux switch as defined in claim 1 wherein said drive comprises an electrostatic drive.

4. The magnetic flux switch as defined in claim 3 wherein said electrostatic drive comprises a comb drive.

5. The magnetic flux switch as defined in claim 1 wherein said drive comprises an piezoelectric drive.

6. The magnetic flux switch as defined in claim 1 and comprising a magnetic material mounted on said substrate at a position spaced from said magnetic flux sensor, wherein said magnetic material attached to said rod is positioned closely adjacent said magnetic material mounted on said substrate when said rod is in said second pivotal position.

7. The magnetic flux switch as defined in claim 1 and comprising a flux outlet and a first flux path extending from said magnetic flux sensor to said flux outlet.

8. The magnetic flux switch as defined in claim 6 and comprising a magnetic material mounted on said substrate at a position spaced from said magnetic flux sensor, wherein said magnetic material attached to said rod is positioned closely adjacent said magnetic material mounted on said substrate when said rod is in said second pivotal position and a second flux path extending from said magnetic material mounted on said substrate and said flux outlet.
